(19) United States
(12) Patent Application Publication
(10) Pub. No.: US 2009/0128063 A1
(43) Pub. Date: May 21, 2009

(54) METHOD FOR DRIVING VIBRATION CUTTER

(75) Inventor: Osamu MIYAZAWA, Shimasuwa-machi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/267,027

(22) Filed: Nov. 7, 2008

(30) Foreign Application Priority Data
Nov. 15, 2007 (JP) 2007-296288

(51) Int. Cl. H02P 31/00

(52) U.S. Cl. 318/3; 318/114

(57) ABSTRACT

A method for driving a vibration cutter includes inputting an alternate current in an actuator section to vibrate a plate-like blade connected to the actuator section, wherein the blade section is vibrated in a plate face direction and a thickness direction of the blade section.

### BACKGROUND

1. Technical Field

The present invention relates to a method for driving a vibration cutter.

2. Related Art

An ultrasonic cutter, one type of vibration cutters, is a mechanical device that vibrates a blade with frequencies in the ultrasonic region to cut an object. To increase mainly the cutting performance (sharpness), various devices have been made as to the intensity of vibration to be added to the blade, the manner the blade is to be vibrated, and the like. As to the manner of vibrating an ultrasonic cutter blade, for example, Japanese Laid-open Patent Application JP-A-2005-153061 proposes an ultrasonic cutter whose blade is elliptically vibrated in a specified plane.

However, if a blade is vibrated only in a specified plane, when the blade enters an object to be cut, a substantial amount of friction occurs between the blade and the object, such that the object may be damaged by frictional heat, or ignited in the worst case.

### SUMMARY

In accordance with an advantage of some aspects of the invention, it is possible to provide a method for driving a vibration cutter that is difficult to generate friction between its blade and an object to be cut during cutting.

A method for driving a vibration cutter in accordance with an embodiment of the invention includes a driving step of inputting an alternate current in an actuator section to vibrate a plate-like blade connected to the actuator section, wherein, in the driving step, the blade section is vibrated in a plate face direction and a thickness direction of the blade section.

As a result, the duration in which the blade section contacts the object to be cut can be reduced, which makes friction between the blade section and the object to be difficult to occur during cutting.

In the method for driving a vibration cutter in accordance with an aspect of the invention, vibration in the plate face direction of the blade section may have an elliptic locus.

In the method for driving a vibration cutter in accordance with an aspect of the invention, a plurality of alternate currents are inputted in the actuator section, and the plurality of alternate currents are mutually different in phase.

In the method for driving a vibration cutter in accordance with an aspect of the invention, a rotation direction of the vibration in an elliptic locus in a plate face direction of the blade section can be reversed by inputting at least one of the alternate currents in an opposite polarity.

In the method for driving a vibration cutter in accordance with an aspect of the invention, the frequency of the alternate current may be 20 kHz or higher but 1 MHz or lower.

In the method for driving a vibration cutter in accordance with an aspect of the invention, the actuator section has a front surface side and a rear surface side each having an electrode, wherein mutually different alternate currents are inputted in the electrodes on the front surface side and the rear surface side, respectively, and the alternate current inputted in the front surface side and the alternate current inputted in the rear surface side are mutually different in amplitude in their voltage waveform.

In the method for driving a vibration cutter in accordance with an aspect of the invention, mutually different alternate currents are inputted in the electrodes on the front surface side and the rear surface side of the actuator section, respectively, a voltage waveform of at least one of the alternate currents may have a plurality of sine waves superposed one another, and phases of the sine waves may be mutually different.

In the method for driving a vibration cutter in accordance with an aspect of the invention, mutually different alternate currents are inputted in the electrodes on the front surface side and the rear surface side of the actuator section, respectively, a voltage waveform of at least one of the alternate currents may have a plurality of sine waves superposed one another, and frequencies of the sine waves may be mutually different.

In the method for driving a vibration cutter in accordance with an aspect of the invention, at least one of the alternate currents may have a resonance frequency of the actuator section or a frequency adjacent to the resonance frequency.

### BRIEF DESCRIPTION OF THE DRAWINGS

FIG. 1 is a schematic plan view of a vibration cutter in accordance with an embodiment of the invention.

FIG. 2 is a schematic cross-sectional view of a blade section and an actuator section in accordance with the embodiment of the invention.

FIG. 3 is a schematic diagram showing an example of displacement of an actuator section in accordance with an embodiment of the invention.

FIG. 4 is a schematic diagram showing an example of displacement of an actuator section in accordance with an embodiment of the invention.

FIG. 5 is a schematic diagram of an example of a circuit structure for a vibration cutter in accordance with an embodiment of the invention.

FIG. 6 is a schematic cross-sectional view showing an operation of an actuator section in accordance with an embodiment of the invention.

FIG. 7 is a schematic cross-sectional view showing an operation of an actuator section in accordance with an embodiment of the invention.

FIG. 8 is a schematic diagram showing an operation of a blade section in accordance with an embodiment of the invention.

FIG. 9 is a schematic diagram showing an operation of a blade section in accordance with an embodiment of the invention.

FIG. 10 is a schematic diagram showing an example of locus of a tip of a blade section in accordance with an embodiment of the invention.

FIG. 11 is a schematic diagram of an example of an alternate current applied to a vibration cutter in accordance with an embodiment of the invention.

FIG. 12 is a schematic diagram of an example of an alternate current applied to a vibration cutter in accordance with an embodiment of the invention.

FIG. 13 is a schematic diagram of an example of an alternate current applied to a vibration cutter in accordance with an embodiment of the invention.

FIG. 14 is a schematic diagram of an example of an alternate current applied to a vibration cutter in accordance with an embodiment of the invention.

### DESCRIPTION OF EXEMPLARY EMBODIMENTS

Preferred embodiments of the invention are described below with reference to the accompanying drawings. It is noted that the embodiments are to be described as examples of the invention.

1. Structure of Vibration Cutter

An example of the structure of a vibration cutter 1000 in accordance with an embodiment of the invention is described with reference to the accompanying drawings. In accordance with an example to be described below, an actuator section 200 of the vibration cutter 1000 has a single blade section 212. However, the invention is not limited to the vibration cutter having such a structure. Vibration cutters to which the present embodiment is applicable may include, for example, a vibration cutter provided with a plurality of blade sections, in addition to the illustrated vibration cutter.

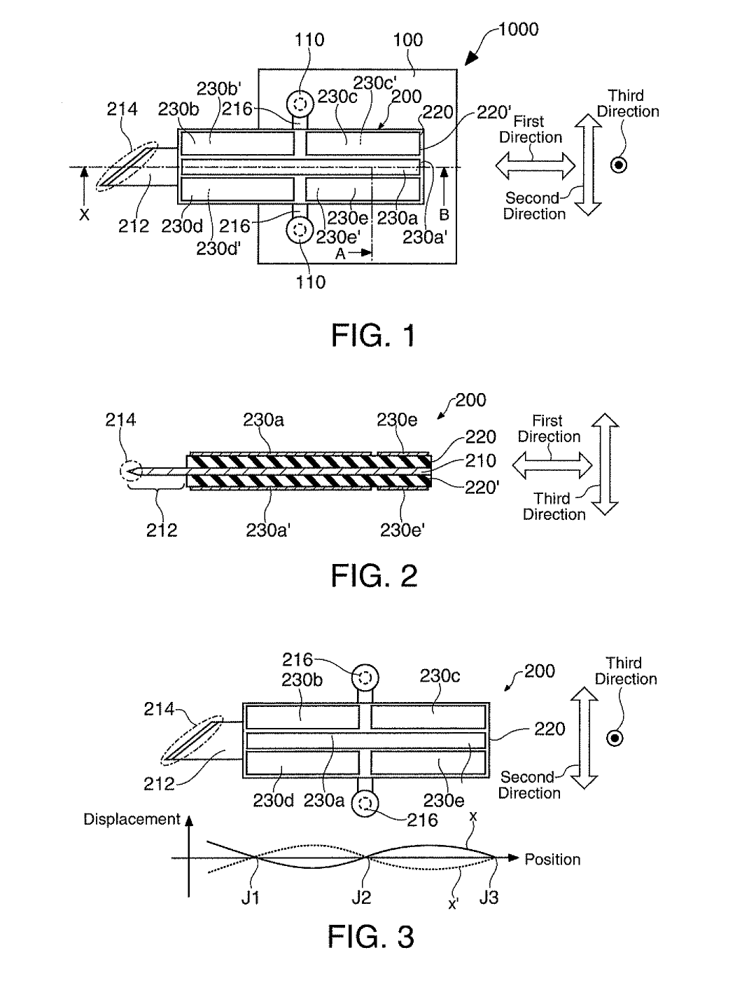

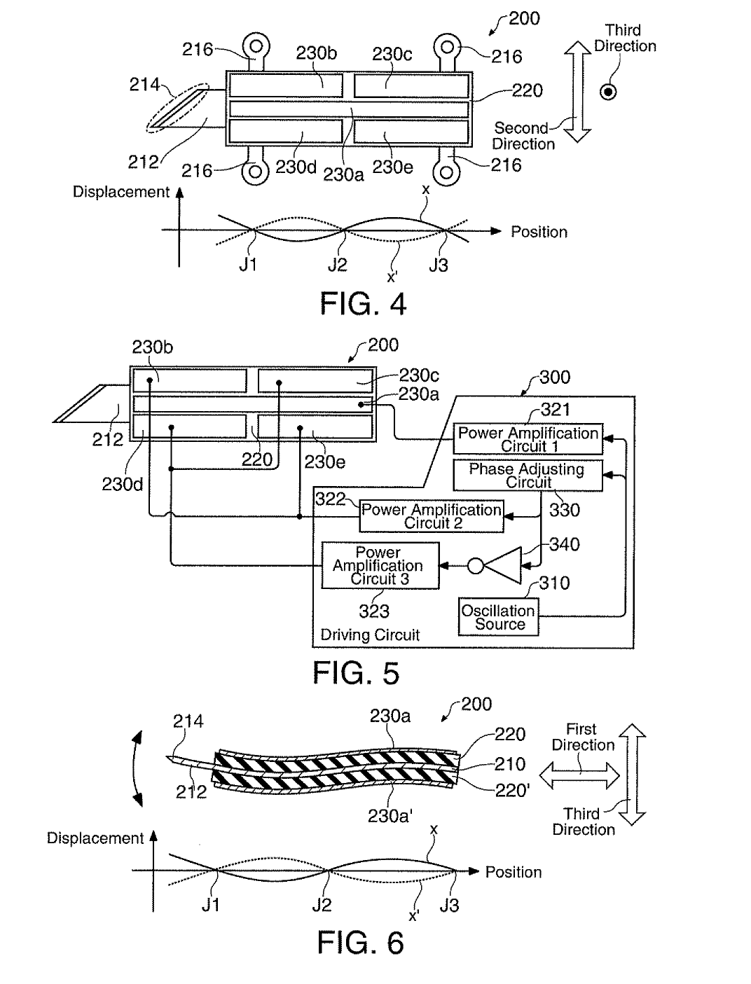

FIG. 1 is a schematic plan view of the vibration cutter 1000 in accordance with the present embodiment. FIG. 2 is a schematic cross-sectional view of an actuator section 200 and a blade section 212 of the vibration cutter 1000 in accordance with the embodiment. A cross section taken along lines X-A of FIG. 1 corresponds to FIG. 2. FIG. 3 and FIG. 4 are schematic diagrams showing vibration of the actuator section 200. Lines indicated below FIG. 3 and FIG. 4 schematically show displacements of the actuator section 200.

The vibration cutter 1000 includes a base substrate 100, the actuator section 200 and the blade section 212.

As shown in FIG. 1 and FIG. 2, the actuator section 200 includes a vibration plate 210, two piezoelectric layers 220 and 220′, two electrodes for longitudinal vibration 230a and 230a′, and eight electrodes for flexural vibration (a portion thereof not illustrated) 230b-230e, and 230b′-230e′. The actuator section 200 may have a structure symmetrical through a central plane of the vibration plate 210 as a mirror surface in a vertical direction in the figure. Accordingly, in the following description, the structure in its upper side (front surface side) above the vibration plate 210 is described, and detailed description of the structure in its lower side (rear surface side) below the vibration plate 210 is omitted.

The actuator section 200 is in a generally rectangular shape as viewed in a plan view. A lengthwise direction of the actuator section 200 extending in a right-to-left direction in FIG. 1 and FIG. 2 is defined as a first direction. A direction in a plate face of the vibration plate 110 in an up-to-down direction in FIG. 1, in other words, a direction perpendicular to the first direction is defined as a second direction. Furthermore, a direction perpendicular to the first direction and the second direction is defined as a third direction. FIG. 1 and FIG. 2 show the first direction, the second direction and the third direction.

The vibration plate 210 is a generally rectangular plate-like member that concurs with the outer configuration of the actuator section 200. The vibration plate 210 is connected to the blade section 212. The vibration plate 210 pairs with the electrodes for vibration, and can be functioned as one of the electrodes that interpose the piezoelectric layers 220 and 220′. For example, the vibration plate 210 can be electrically grounded. The vibration plate 210 has fixing sections 216. The fixing sections 216 are provided to affix the actuator section 200 to the base substrate 100. For example, as shown in FIG. 1, fasteners 110 may be used to affix the fixing sections 216 to the base substrate 100, thereby affixing the actuator section 200 to the base substrate 100. The vibration plate 210 is capable of extension and contraction in the first direction and flexural motions in the second direction and the third direction by extension and contraction of the upper and lower (front surface side and rear surface side) piezoelectric layers 220 and 220′, whereby the blade section 212 can be vibrated. The blade section 212 is vibrated by the vibration of the vibration plate 210, such that an object to be cut can be cut by the blade section 212. For example, stainless steel may preferably be used as the material for the vibration plate 210. The vibration plate 210 and the blade section 212 may be formed in one piece, or may be mechanically connected to each other. In the illustrated example, the vibration plate 210 is formed in one piece with the blade section 212.

The piezoelectric layer 220 is provided on the vibration plate 210. The piezoelectric layer 220 is capable of extension and contraction upon application of alternate currents. The direction of extension and contraction may be arbitrarily designed according to the polarities of alternate currents to be applied and the direction of polarization of the piezoelectric layer 220. In the example shown in FIG. 1 and FIG. 2, the four electrodes for flexural vibration 230b-230e are arranged, such that the piezoelectric layer 220 is in a single layer and subjected to a polarization treatment in one direction. In this example, the piezoelectric layer can have extension and contraction at portions corresponding to the electrodes according to polarities of alternate currents to be applied to the electrodes. The piezoelectric layer 220 may be formed from a piezoelectric material, such as, for example, lead zirconate titanate (Pb (Zr, Ti) O₃), lead zirconate titanate niobate (Pb (Zr, Ti, Nb) O₃) or the like.

The electrode for longitudinal vibration 230a is provided on the piezoelectric layer 220. The electrode for longitudinal vibration 230a is capable of supplying an alternate current for extension and contraction of the piezoelectric layer 220 in the first direction. The electrode for longitudinal vibration 230a pairs with the electrode for longitudinal vibration 230a′ at the rear surface side. Therefore, when the piezoelectric layer 220 and the piezoelectric layer 220′ extend and contract in the first direction in the same magnitude by the electrode for longitudinal vibration 230a and the electrode for longitudinal vibration 230a′, respectively, the vibration plate 210 can be extended and contracted in the first direction. When the piezoelectric layer 220 and the piezoelectric layer 220′ extend and contract in the first direction in different magnitudes by the electrode for longitudinal vibration 230a and the electrode for longitudinal vibration 230a′, respectively, the vibration plate 210 can be flexed in the third direction.

The electrodes for flexural vibration 230b-230e are provided on the piezoelectric layer 220. The electrodes for flexural vibration 230b-230e are capable of supplying alternate currents for flexurally vibrating the vibration plate 210, in other words, the actuator section 200 in the second direction. The electrodes for flexural vibration 230b-230e pair with the electrodes for flexural vibration 230b′-230e′ at the rear surface side, respectively. When the piezoelectric layer 220 and the piezoelectric layer 220′ extend and contract in different magnitudes by alternate currents inputted in the electrodes for flexural vibration 230b-230e and the electrodes for flexural vibration 230b′-230e′, the vibration plate 210 can be flexed in the third direction. Flexural vibration in the second direction may be generated by, for example, inputting alternate currents having mutually opposite polarities in the electrodes for flexural vibration 230b and 230b′ and the electrodes for flexural vibration 230d and 230d′. As a result, in a certain instance, when the piezoelectric layers 220 and 220′ extend in the first direction in portions corresponding to the electrodes for flexural vibration 230b and 230b′, the piezoelectric layers 220 and 220′ contract in the first direction in portions corresponding to the electrodes for flexural vibration 230d and 230d′, such that the actuator section 200 flexes in the second direction in a manner that the contracting portions of the piezoelectric layers 220 and 220′ corresponding to the electrodes for flexural vibration 230d and 230d′ define an inner side of the flex. In another instance, when the piezoelectric layers 220 and 220′ contract in the first direction in portions corresponding to the electrodes for flexural vibration 230b and 230b′, the piezoelectric layers 220 and 220′ extend in the first direction in portions corresponding to the electrodes for flexural vibration 230d and 230d′, such that the actuator section 200 flexes in the second direction in a manner that the contracting portions of the piezoelectric layers 220 and 220′ corresponding to the electrodes for flexural vibration 230b and 230b′ define an inner side of the flex. When alternate currents having mutually opposite polarities are applied to the actuator section 200 in a manner described above, the actuator section 200 continuously repeats the actions described above, and therefore flexurally vibrates in the second direction. As long as the actuator 200 is provided with the function described above, the number, arrangement and configuration of the electrodes can be arbitrarily designed. Also, flex and extension and contraction can be generated by using certain arrangements of the polarization states of the piezoelectric layer 220. In the example described above, the electrode on each of the front surface side and the back surface side of the actuator section 200 is divided into five segments. However, the configuration and the number of the electrodes may be arbitrarily decided as long as vibration modes to be described below can be obtained.

The actuator section 200 described above has a resonance frequency in each of the first direction, the second direction and the third direction. The actuator section 200 of the vibration cutter 1000 in accordance with the present embodiment can be designed such that the resonance frequency in the first direction, the resonance frequency in the second direction and the resonance frequency in the third direction are close to one another. Moreover, at least one of the alternate currents to be inputted to the actuator section 200 can be set to be the same as one of the resonance frequencies of the actuator section 200 or to its neighboring frequency. As a result, the energy of the inputted alternate currents can be effectively converted into vibration energy. In other words, the power required for cutting an object by the vibration cutter 1000 can be suppressed to a minimum.

Moreover, when the actuator section 200 is vibrated with the resonance frequency or its neighboring frequency in one of the directions of the actuator section 200, an area that defines a node of vibration can be generated in the operation of the actuator section 200. The area that defines a node of vibration is an area with a very small displacement in the actuator section 200 (the vibration plate 210) in any of the first-third directions. If the fixing sections 216 are provided in such an area, the vibration energy of the actuator section 200 which may dissipate through the fixing sections 216 can be made smaller. Therefore, the power required for cutting an object by the vibration cutter 1000 can be suppressed to a minimum.

A line x and a line x′ indicated in a lower portion of each of FIG. 3 and FIG. 4 schematically show displacements of the actuator section 200. Displacements of the actuator section 200 in the figures in one of the first direction, the second direction and the third direction, or a direction of a composite of plural directions are plotted along an axis of ordinates, and positions of the actuator section 200 are plotted along an axis of abscissas.

FIG. 3 shows an example of the actuator section 200 that vibrates in a manner to have a node of vibration J2 at a portion thereof, wherein two fixing sections 212 are provided in areas near the node of vibration J2. When the fixing sections 216 are provided at such positions, energy loss at the time of driving the vibration cutter 1000 can be made smaller. FIG. 4 shows an example of the actuator section 200 that vibrates in a manner to have nodes of vibration J1, J2 and J3, wherein four fixing sections 216 are provided in areas near the nodes of vibration J1 and J3. When the fixing sections 216 are provided at such positions, energy loss at the time of driving the vibration cutter 1000 can be made smaller, and the rigidity of the vibration cutter 1000 can be increased by the increased number of fixing sections 216. Accordingly, the vibration cutter 1000 is applicable to a wider range of objects to be cut.

The blade section 212 is provided in a manner to extend from one end of the actuator section 200 in the first direction. In the example shown in FIG. 2, the blade section 212 and the vibration plate 210 are formed in one piece. The blade section 212 may be provided as a member independent of the vibration plate 210. The blade section 212 is in a plate-like shape, and a plate face of the plate is provided in parallel with a plate face of the vibration plate 210. The direction of the plate face of the blade section 212 concurs with the direction of the plate face of the vibration plate 210 of the actuator section 200. A front surface side of the blade section 212 corresponds to one of the front surface side and the rear surface side of the actuator section 200 described above, and a rear surface side of the blade section 212 corresponds to the other of the surface sides of the actuator section 200 described above. The blade section 212 may be a single-edged blade as illustrated or a double-edged blade although not shown. The blade section 212 has a blade tip 214 which cuts into an object to be cut. The blade tip 214 is provided at an end section of the blade section 212, and becomes thinner toward its pointed end. The blade tip 214 may be provided in a curved or zigzagged shape. The blade section 214 is provided in one piece with the actuator section 200, and therefore vibrates according to vibration of the actuator section 200. The blade section 212 can vibrate in the first direction through the third direction by driving the actuator section 200. The blade section 212 may enter an object to be cut, may be pulled out from an object to be cut, and may be scraped against an object to be cut. The material for the blade section 212 may be appropriately selected according to objects to be cut. As the material for the blade section 212, for example, stainless steel, high hardness steel, molybdenum steel or the like, or ceramics may be used.

2. Circuit Structure of Vibration Cutter

FIG. 5 is a schematic circuit diagram of a vibration cutter 1000 in accordance with an embodiment of the invention.

Each of the electrodes on the actuator section 200 is electrically connected to a driving circuit 300. In the example shown in FIG. 5, the electrodes for flexural vibration 230b-230e are connected to a phase adjusting circuit 330. The driving circuit 300 is provided with a total of two power amplification circuits, one each for each two of the four electrodes for flexural vibration, and another power amplification circuit for the electrode for longitudinal vibration. The driving circuit 300 further includes an oscillation source 310, and an inverter 340. The phase adjusting circuit 330 is provided for changing the phase of flexural vibration, in other words, vibration in the second direction, with respect to the phase of longitudinal vibration, in other words, vibration in the first direction. By this, an arbitrary phase difference can be generated between vibrations in the first direction and the second direction. The inverter 340 inverts the polarities of alternate currents to be applied to the electrodes for flexural vibration 230c and 230d and the electrodes for flexural vibration 230b and 230e. The oscillation source 310 generates a driving frequency, and the driving frequency is a frequency of alternate current to be inputted in the actuator section 200. The frequency of the alternate current may be selected to match with the size and the shape of the actuator section 200. The frequency of the alternate current may preferably be 20 kHz or higher but 1 MHz or lower. A plurality of oscillation sources 310 may be provided. The power amplification circuits 321-323 amplify the inputted signal to the level that can drive the actuator section 200. Variables for driving the vibration cutter 1000 having the structure described above may be an oscillation frequency (driving frequency) of the oscillation source 310, a phase difference given by the phase adjusting circuit 330, and the amplification efficiency of (i.e., the magnitude of the amplitude of alternate current to be applied to the electrode from) the power amplification circuits 321-323. These variables can be changed independently from one another.

The structure of the driving circuit 300 described above can be similarly provided for the rear surface side of the actuator section 200 (not shown). Furthermore, the entirety or a part of the driving circuit 300 may be commonly used for the front surface side and the rear surface side. Moreover, mutually different alternate currents can be applied to the electrodes on the front surface side and the rear surface side (the electrodes for longitudinal vibration 230a and 230a′ and the electrodes for flexural vibration 230b-230e, and 230b′-230e′) of the actuator section 200. Also, the voltage waveform of an alternate current to be supplied to each of the electrodes may be defined by a plurality of superposed sine waves in which at least one of frequency, phase and amplitude thereof is different from the others. Furthermore, when a plurality of oscillation sources 310 and/or a plurality of frequency adjusting circuits are provided, the voltage waveform of an alternate current to be supplied to each of the electrodes may be defined by a plurality of superposed sine waves generated by these oscillation sources and frequency adjusting circuits. Details of an alternate current to be supplied to each of the electrodes are described below.

In a manner described above, AC voltages can be applied to the piezoelectric layer 220 and the piezoelectric layer 220′, but the driving circuit 300 and the vibration plate 210 may be grounded (not shown). As a result, the vibration plate 210 can be functioned as a common (ground) electrode. By applying a desired AC voltage to the piezoelectric layer interposed between the vibration plate 210 and each of the electrodes for vibration, the piezoelectric layer can be provided with a desired vibration.

3. Method for Driving Vibration Cutter

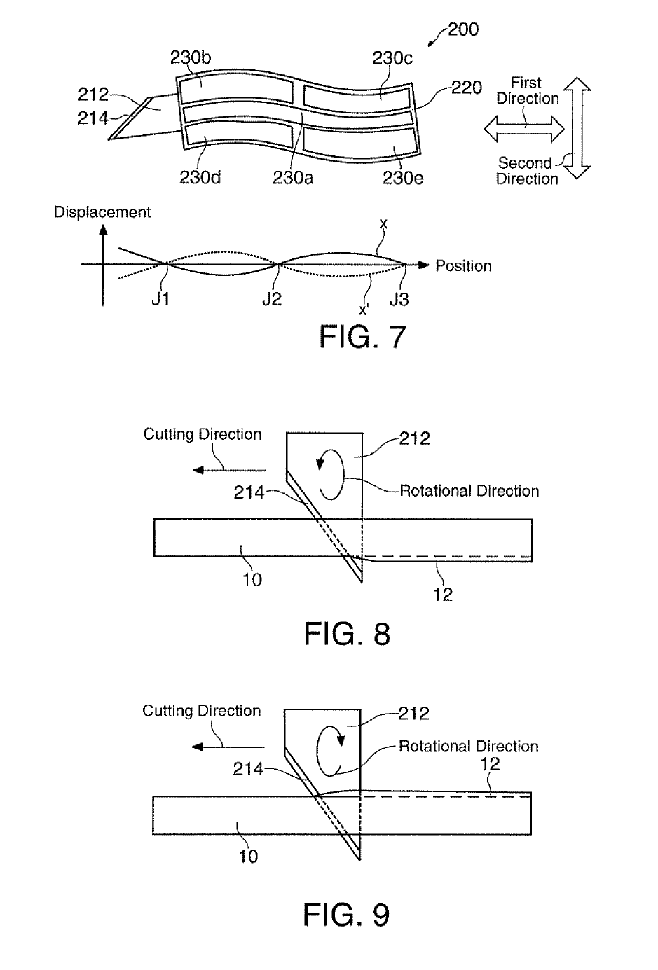

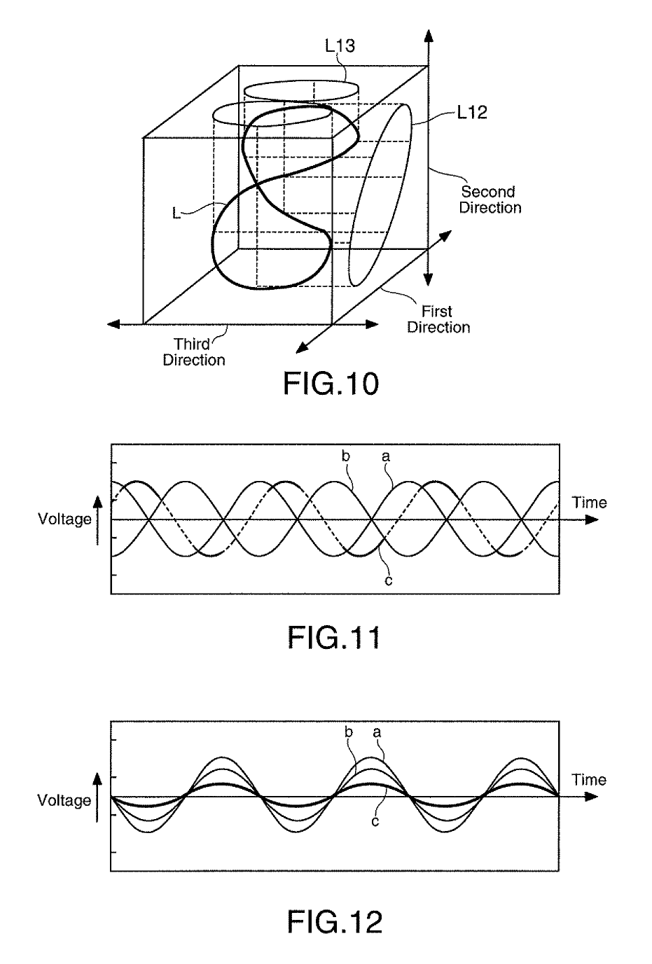

FIG. 6 is a schematic cross-sectional view showing a configuration of the actuator section 200 that can momentarily assume when flexurally vibrating in the third direction. FIG. 6 corresponds to a cross section taken along a line X-B in FIG. 1. FIG. 7 is a schematic plan view showing a configuration of the actuator section 200 that can momentarily assume when flexurally vibrating in the second direction. FIG. 8 and FIG. 9 are schematic diagrams showing states in which the blade section 212 is cutting an object. FIG. 10 is a schematic diagram showing an example of locus of the tip of the blade section 212.

As shown in FIG. 6, the actuator section 200 can flex in the third direction according to the polarities of alternate currents applied to the respective electrodes. The flex illustrated in FIG. 6 is exaggerated for description. In the case of this figure, the alternate currents applied to the electrodes for flexural vibration 230b-230e on the front surface side and the electrodes for flexural vibration 230b′-230e′ on the rear surface side of the actuator section 200 have mutually opposite polarities. In other words, alternate currents which contract the vibration plate 210 in the first direction are applied to the electrodes for flexural vibration 230b, 230d, 230c′ and 230e′. Further, alternate currents which extend the vibration plate 210 in the first direction are applied to the electrodes for flexural vibration 230c, 230e, 230b′ and 230d′. As a result, the actuator section 200 momentarily assumes a waving configuration as shown in FIG. 6. Then, as alternate currents are applied to the respective electrodes, the actuator section 200 assumes a configuration in which the waving state is reversed in another moment. With the frequencies of the alternate currents, the actuator section 200 flexurally vibrates in the third direction. At the same time, alternate currents can also be applied to the electrodes for longitudinal vibration 230a and 230a′, such that flexural vibration in the third direction and extension and contraction vibration (longitudinal vibration) in the first direction can be concurrently generated in the actuator section 200. Furthermore, alternate currents that cause flexural vibration in the second direction as shown in FIG. 7 can be concurrently applied to the respective electrodes for flexural vibration. The phase, frequency and intensity of each of the vibrations in the three directions can be arbitrarily adjusted by the driving circuit 300 described above. Depending on a combination (composition) of vibrations in the respective directions, the locus of the tip of the blade section 200 may have a vibration component in the third direction as shown in FIG. 6, for example. FIG. 10 three-dimensionally shows an example of such vibrations as described above.

FIG. 10 is a schematic diagram three-dimensionally depicting a locus L of the tip of the blade section 212. A projected line L12 indicates the locus L projected on a plane including the first direction and the second direction. A projected line L13 indicates the locus L projected on a plane including the first direction and the third direction. In the case of the example in FIG. 10, the locus L of the tip of the blade section 212 is in an elliptic shape in the projection on the plane including the first direction and the second direction, in other words, in a plate face direction of the blade section 212. Vibration that results in the projected line L12 having such a shape can be obtained by applying the alternate currents described above to the electrodes for longitudinal vibration 230a and the electrodes for flexural vibration 230b-230e and 230b′-230e′ of the actuator section 200. On the other hand, the locus L of the tip of the blade section 212 projected on the plane including the first direction and the third direction, in other words, in the thickness direction of the blade section 212, defines a letter eight in Arabic number (the projected line L13). Vibration that results in such a projection can be obtained by applying mutually different alternate currents to the electrodes on the front surface side and the rear surface side of the actuator section 200, respectively. A set of the mutually different alternate currents shall be described in detail below.

The rotational direction of the vibration in an elliptic shape in the plate face direction of the blade section 212 can be reversed by inverting the polarities of the alternate currents applied to the respective electrodes. By this, the position of a bur 12 that may be generated on an object to be cut 10 can be changed. For example, as shown in FIG. 8 and FIG. 9, when the blade section 212 enters the object to be cut 10, friction is generated and a bur 12 or cut powder may be generated at the object 10 toward a direction in which the blade section 212 enters. In such an instance, by selecting polarities of the alternate currents to be applied to the respective electrodes, the direction in which the bur 12 and/or cut powder are generated can be changed. Therefore, for example, when the object to be cut 10 is a laminate such as a coated paper, the rotational direction of the blade section 212 may be selected, such that the direction of a bur 12 to be generated after cutting the object 10 can be adjusted. Also, by selecting the rotational direction of the blade section 212, the object to be cut 10 can be cut without destroying the object 10. For example, when the object to be cut is a coated paper, by selecting the rotational direction of the blade section 212 in a manner not to generate a bur 12 on the coated surface side of the coated paper, the coat of the coated paper is difficult to be peeled off at the time of cutting, and destruction of the cut coated paper can be prevented.

Next, the relation between vibrations of the blade section 212 and alternate currents to be applied is further described, using concrete examples of voltage waveforms of alternate currents to be applied to the electrodes.

FIGS. 11 through 14 are graphs of examples of alternate currents to be inputted in the actuator section 200, wherein voltage values of the alternate currents are plotted along an axis of ordinates, and the time is plotted along an axis of abscissas. FIG. 11 shows an example of alternate currents that generate vibration in the plate face direction of the actuator section 200. A curve a in FIG. 11 indicates a voltage waveform of a current applied to the electrodes for longitudinal vibration 230a and 230a′. A curve b in FIG. 11 indicates a voltage waveform of a current applied to the electrodes for flexural vibration 230b, 230b′, 230e and 230e′. A curve c in FIG. 11 indicates a voltage waveform of a current applied to the electrodes for flexural vibration 230c, 230c′, 230d and 230d′.

The actuator section 200 in which the currents shown in FIG. 11 are inputted vibrates in a manner that the blade section 212 is vibrated in an elliptic locus in the plate face direction of the actuator section 200. The same alternate currents shown in FIG. 11 are inputted in the electrodes on the front surface side of the actuator section 200 and in the corresponding electrodes on the rear surface side, respectively. Therefore, the alternate currents applied to the electrodes on the front surface side and the rear surface side of the actuator section 200 are inputted symmetrically with respect to the vibration plate 210, such that flexural vibration in the thickness direction of the actuator section 200 (in the third direction) is not generated. Vibration in the thickness direction of the actuator section 200 (in the third direction) may be generated by, for example, various methods to be described below.

A curve a in FIG. 12 indicates a voltage waveform of an alternate current to be applied to one of the electrodes on the front surface side of the actuator section 200. A curve b in FIG. 12 indicates a voltage waveform of an alternate current to be applied to an electrode on the rear surface side corresponding to the electrode on the front surface side to which the alternate current in the curve a is applied. The curve b and the curve a have different amplitudes, but have the same phase and the same frequency. A curve c in FIG. 12 indicates a difference between the curve a and the curve b. The curve c is a sine wave, and indicates that there is a difference in the voltage (amplitude) between the alternate currents applied to the electrode on the front surface side and the electrode on the rear surface side, which indicates that they are mutually different through the vibration plate 210. When the amplitude of the alternate current applied to the electrode on the front surface side of the actuator section 200 is different from the amplified of the alternate current applied to the corresponding electrode on the rear surface side, a difference occurs in the amount of extension and contraction between the piezoelectric layer 220 and the piezoelectric layer 220′ at the area of the electrodes. As a result, the actuator section 200 can generate a vibration component in the third direction.

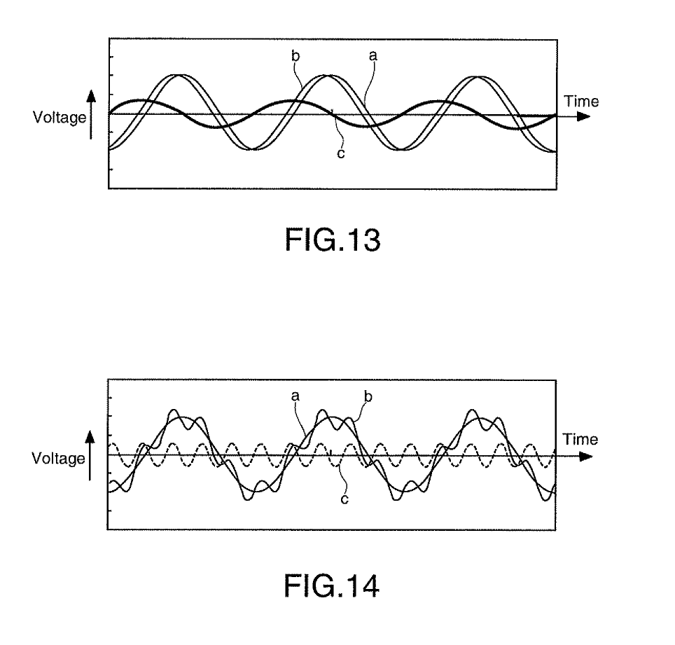

A curve a in FIG. 13 indicates a voltage waveform of an alternate current to be applied to one of the electrodes on the front surface side of the actuator section 200. A curve b in FIG. 13 indicates a voltage waveform of an alternate current to be applied to an electrode on the rear surface side corresponding to the electrode on the front surface side to which the alternate current in the curve a is applied. The curve b and the curve a have different phases, but have the same amplitude and the same frequency. A curve c in FIG. 13 indicates a difference between the curve a and the curve b. The curve c is a sine wave, and indicates that the alternate currents applied to the electrode on the front surface side and the electrode on the rear surface side are mutually different, like the example described above. When the phase of the alternate current applied to the electrode on the front surface side of the actuator section 200 is different from the phase of the alternate current applied to the corresponding electrode on the rear surface side, a difference occurs in the amount of extension and contraction between the piezoelectric layer 220 and the piezoelectric layer 220′ at the area of the electrodes. As a result, the actuator section 200 can generate a vibration component in the third direction.

A curve a in FIG. 14 indicates a voltage waveform of an alternate current to be applied to one of the electrodes on the front surface side of the actuator section 200. A curve b in FIG. 14 indicates a voltage waveform of an alternate current to be applied to an electrode on the rear surface side corresponding to the electrode on the front surface side to which the alternate current in the curve a is applied. The curve b is formed by superposing a sine wave having a different frequency on the curve a. A curve c in FIG. 14 indicates a difference between the curve a and the curve b. The curve c is a sine wave, and indicates that the alternate currents applied to the electrode on the front surface side and the electrode on the rear surface side are mutually different. In the example shown in the figure, the curve c is a sine wave with a greater frequency than that of the curve a, but may be superposed such that the curve c becomes a sine wave with a smaller frequency than that of the curve a. As shown in FIG. 14, when the alternate current applied to the electrode on the front surface side of the actuator section 200 is different from the alternate current applied to the corresponding electrode on the rear surface side, a difference occurs in the amount of extension and contraction between the piezoelectric layer 220 and the piezoelectric layer 220′ at the area of the electrodes. As a result, the actuator section 200 can generate a vibration component in the third direction.

Furthermore, vibration of the blade section 212 in the thickness direction may be generated by the methods described above as examples, and two or more of the methods described above may be appropriately combined. Also, the sets of the electrodes on the front surface side and the rear surface side may be any of the electrodes shown in the figures, as long as they are located at corresponding positions on the front and rear side surfaces. Furthermore, plural ones of the electrodes on one side may be treated as one electrode, for the purpose of controlling, and alternate currents different between the front surface side and the rear surface side may be applied across the aforementioned electrodes and their corresponding electrodes on the other surface side, whereby vibration of the blade section 212 in the thickness direction can be achieved.

The method of inputting alternate currents in the actuator section 200 which generates vibration of the blade section 212 in the thickness direction may be combined with the method of inputting alternate currents in the actuator section 200 which generates elliptic vibration of the blade section 212 in the plate face direction. In other words, while inputting the alternate currents shown in FIG. 11 in the respective electrodes of the actuator 200, currents may be inputted in any one of the pairs of the electrodes on the front surface side and the rear surface side in a manner to form the set of alternate currents shown in any one of FIG. 12 through FIG. 14, whereby the blade section 212 can be vibrated in an elliptic locus in the plate face direction, and also vibrated in the thickness direction.

As described above, according to the method for driving a vibration cutter in accordance with an embodiment of the invention, the blade section 212 can be vibrated in the plate face direction and the thickness direction, when cutting an object to be cut. According to such a driving method, the blade section 212 can be elliptically vibrated in the plate face direction, and also vibrated in the thickness direction at the same time. As a result, when cutting an object to be cut, the blade section 212 enters the object to be cut by vibration of the blade section 212 in the plate face direction, and the blade section 212 and the object to be cut are prevented by vibration in the thickness direction from continuously contacting each other in the object to be cut. Also, when cutting an object to be cut, vibration of the blade section 212 in the thickness direction acts to widen the cut in the object to be cut. Therefore, the blade section 212 and the object to be cut have a fewer contacts, and the time duration in which the blade section 212 is in contact with the object to be cut can be shortened. Therefore, friction generated between the blade section 212 and the object to be cut can be reduced. Accordingly, the object to be cut can be substantially prevented from burning or igniting during cutting. Also, according to the method for driving a vibration cutter in accordance with the present embodiment, when an object to be cut is cut by the vibration cutter 1000, friction generated between the blade section 212 and an object to be cut can be suppressed, the object to be cut can be cut while suppressing deformation, such as, burs and the like, of the object to be cut.

The embodiments of the invention are described above in detail. However, those skilled in the art should readily understand that many modifications can be made without departing in substance from the novel matter and effects of the invention. Accordingly, those modified examples are also deemed to be included in the scope of the invention.

What is claimed is:

1. A method for driving a vibration cutter comprising:
inputting an alternate current in an actuator section to vibrate a plate-like blade connected to the actuator section, wherein the blade section is vibrated in a plate face direction and a thickness direction of the blade section.

2. A method for driving a vibration cutter according to claim 1, wherein vibration in the plate face direction of the blade section has an elliptic locus.

3. A method for driving a vibration cutter according to claim 1, wherein a plurality of alternate currents are inputted in the actuator section, and the plurality of alternate currents are mutually different in phase.

4. A method for driving a vibration cutter according to claim 3, wherein a rotation direction of the vibration in the elliptic locus in the plate face direction of the blade section is reversed by inputting at least one of the alternate currents in an opposite polarity.

5. A method for driving a vibration cutter according to claim 1, wherein the frequency of the alternate current is between 20 kHz and 1 MHz.

6. A method for driving a vibration cutter according to claim 1, wherein the actuator section has a front surface side and a rear surface side each having at least one electrode, wherein mutually different alternate currents are inputted in the electrodes on the front surface side and the rear surface side, respectively, and the alternate current inputted in the front surface side and the alternate current inputted in the rear surface side are mutually different in amplitude in voltage waveform.

7. A method for driving a vibration cutter according to claim 1, wherein the actuator section has a front surface side and a rear surface side each having at least one electrode, wherein mutually different alternate currents are inputted in the electrodes on the front surface side and the rear surface side, respectively, and a voltage waveform of at least one of the alternate currents has a plurality of sine waves superposed one another, and phases of the sine waves are mutually different.

8. A method for driving a vibration cutter according to claim 1, wherein the actuator section has a front surface side and a rear surface side each having at least one electrode, wherein mutually different alternate currents are inputted in the electrodes on the front surface side and the rear surface side of the actuator section, respectively, a voltage waveform of at least one of the alternate currents has a plurality of sine waves superposed one another, and frequencies of the sine waves are mutually different.

9. A method for driving a vibration cutter according to claim 1, wherein at least one of the alternate currents has a resonance frequency of the actuator section or a frequency adjacent to the resonance frequency.
